(19) United States
(12) Patent Application Publication
(10) Pub. No.: US 2019/0141598 A1
(43) Pub. Date: May 9, 2019

(54) INCREASING NETWORK COVERAGE USING RATE ADAPTATION

(71) Applicant: QUALCOMM Incorporated, San Diego, CA (US)

(72) Inventors: Nikolai Konrad LEUNG, San Francisco, CA (US); Venkatraman Srinivasa ATTI, San Diego, CA (US)

(21) Appl. No.: 16/171,663

(22) Filed: Oct. 26, 2018

Related U.S. Application Data
(60) Provisional application No. 62/742,846, filed on Oct. 8, 2018.
(60) Provisional application No. 62/583,435, filed on Nov. 8, 2017.

(51) Int. Cl. H04W 36/30; H04L 12/26

(52) U.S. Cl. CPC H04W 36/30; H04L 43/0829

(57) ABSTRACT

Aspects of the present disclosure provide techniques and apparatus for wireless communication, and more particularly, increasing network coverage using rate adaption. The techniques include adjusting a cell transition threshold based on, for example, maximum packet loss rates (PLRs) for a VOIP terminal, for example, taking into consideration application layer redundancy employed at the terminal. Numerous other aspects are provided.

### CLAIM OF PRIORITY UNDER 35 U.S.C. § 119

This application claims the benefit of U.S. Provisional Patent Application Ser. No. 62/583,435, filed Nov. 8, 2017, and U.S. Provisional Patent Application Ser. No. 62/742,846, filed Oct. 8, 2018, both of which are herein incorporated by reference in their entirety.

### FIELD OF THE DISCLOSURE

Aspects of the present disclosure relate generally to wireless communications, and more particularly, to techniques and apparatus for improving coverage in wireless networks during communication sessions, such as voice over IP (VOIP) calls.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology.

As the demand for mobile broadband access continues to increase, there exists a need for further improvements in wireless technologies. Preferably, these improvements should be applicable to multi-access technologies and the telecommunication standards that employ these technologies.

One example of such improvement is the ability for a media receiver, such as a user equipment (UE), to request a sender (e.g., another UE) to switch to a more robust codec configuration when it detects high packet loss during a media session. Unfortunately, if the corresponding network entities are unaware of this ability, they may set packet loss rate (PLR) handover thresholds based on less robust codec configurations. This may lead to premature handover, triggered by a given PLR, before the media receiver has the opportunity to request a switch to a more robust codec configuration.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide a method for wireless communications by a network entity. The method generally includes receiving signaling of information indicating capability of a UE to handle at least one target packet loss rate (PLR) and determining, based on the information, a maximum PLR associated with the UE.

Certain aspects of the present disclosure provide a method for wireless communications by a UE. The method generally includes signaling information indicating capability of the UE to handle at least one target packet loss rate (PLR), the signaling designed to allow a network entity to determine one or more thresholds for handover of the UE from a packet switched (PS) radio access network (RAN) to a circuit switched (CS) radio access network (RAN), and employing application layer redundancy to transmit a plurality of voice over Internet Protocol (VoIP) packets.

Certain aspects of the present disclosure provide a method for wireless communications by a network entity. The method generally includes receiving signaling of a parameter indicating capability of a first user equipment (UE) to request, during a media session with a second UE, that the second UE switch from a first codec configuration to a second codec configuration and determining one or more thresholds for handover of the UE, based on the parameter.

Certain aspects of the present disclosure provide a method for wireless communications by a UE. The method generally includes signaling, to a network entity, parameter indicating capability of the first UE to request, during a media session with a second UE, that the second UE switch from a first codec configuration to a second codec configuration, detecting a packet loss rate (PLR) above a threshold value, while participating in the media session with the second UE using the first codec configuration, and requesting, in response to detecting the PLR above the threshold value, that the second UE switch from to the second codec configuration.

Numerous other aspects are provided including methods, apparatus, systems, computer program products, and processing systems.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an exemplary deployment in which multiple wireless networks have overlapping coverage, in accordance with certain aspects of the present disclosure.

FIG. 2 shows a block diagram conceptually illustrating an example of a base station in communication with a user equipment (UE) in a wireless communications network, in accordance with certain aspects of the present disclosure.

FIG. 3 illustrates an example call flow for a mobile originated (MO) call, in accordance with certain aspects of the present disclosure.

FIG. 4 illustrates an example call flow for a mobile terminated (MT) call, in accordance with certain aspects of the present disclosure.

FIG. 5 illustrates an example voice over IP (VOIP) scenario, in accordance with certain aspects of the present disclosure.

FIG. 6 illustrates example operations for wireless communications by a user equipment (UE), in accordance with certain aspects of the present disclosure.

FIG. 7 illustrates example operations for wireless communications by a network entity, in accordance with certain aspects of the present disclosure.

FIG. 8 illustrates an example scenario in which an adaptation parameter is indicated, in accordance with certain aspects of the present disclosure.

FIG. 9 illustrates an example scenario in which an adaptation parameter is not indicated.

FIG. 10 illustrates example operations for wireless communications by a UE, in accordance with certain aspects of the present disclosure.

FIG. 11 illustrates example operations for wireless communications by a network entity, in accordance with certain aspects of the present disclosure.

FIG. 12 illustrates an example table indicating media receive support for adaptation, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure provide techniques that allow a network entity to determine a maximum packet loss rate (MaxPLR) supported by a VOIP terminal and/or adjust handover thresholds based on the maximum packet loss rate (MaxPLR) supported by a VOIP terminal, such as a Voice over LTE (VoLTE) UE. The actual MaxPLR may depend, for example, on a type of redundancy employed by the UE to re-transmit part or all of one or more voice frames to improve reliability. For example, application layer redundancy (where entire voice frames may be repeatedly transmitted) may allow a UE to tolerate a higher MaxPLR than it could otherwise tolerate.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as code division multiple access (CDMA), time division multiple access (TDMA), frequency division multiple access (FDMA), orthogonal FDMA (OFDMA), single carrier FDMA (SC-FDMA) and other networks. The terms “network” and “system” are often used interchangeably. A CDMA network may implement a radio access technology (RAT) such as universal terrestrial radio access (UTRA), cdma2000, etc. UTRA includes wideband CDMA (WCDMA) and other variants of CDMA. cdma2000 covers IS-2000, IS-95 and IS-856 standards. IS-2000 is also referred to as 1× radio transmission technology (1×RTT), CDMA2000 1×, etc. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP long-term evolution (LTE) and LTE-Advanced (LTE-A) are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques and apparatus described herein may be used for the wireless networks and RATs mentioned above as well as other wireless networks and RATs.

Circuit-switched fallback (CSFB) is a technique to deliver voice-services to a UE, when the UE is camped in a long-term evolution (LTE) network. This may be required when the LTE network does not support voice services natively. The LTE network and a 3GPP CS network (e.g., UMTS or GSM) may be connected using a tunnel interface. The UE may register with the 3GPP CS network while on the LTE network by exchanging messages with the 3GPP CS core network over the tunnel interface.

### An Example Wireless Communications System

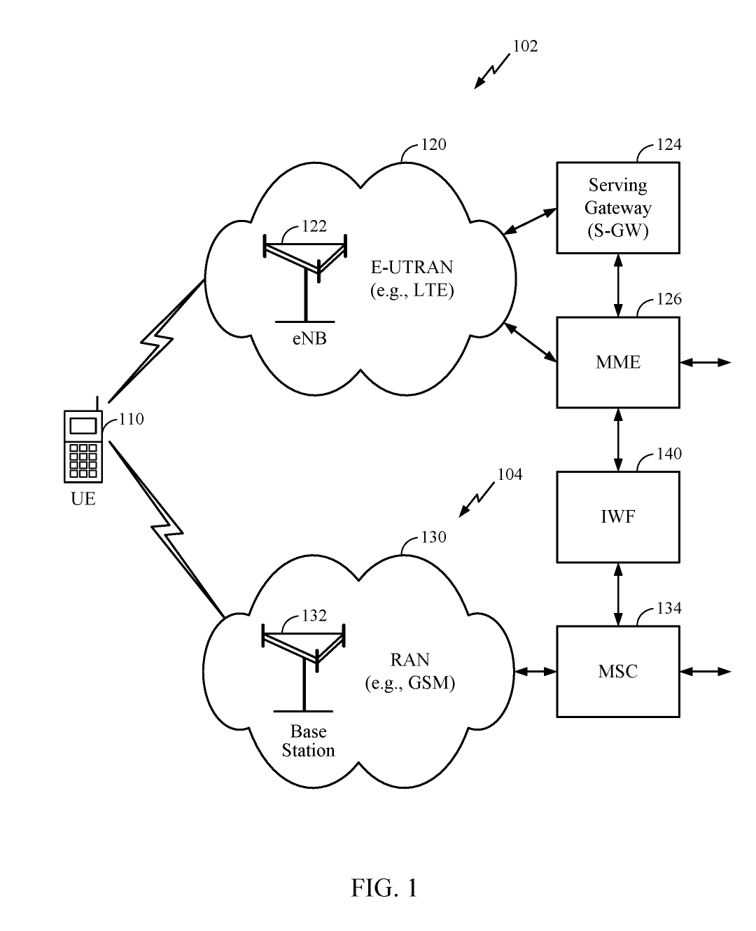

FIG. 1 shows an exemplary deployment in which multiple wireless networks have overlapping coverage, in which aspects of the present disclosure may be performed. For example, a UE 110 may receive one or more session initiation protocol (SIP) requests (e.g., SIP:INVITE messages), from one or more other UEs 110 (e.g., via eNB 122), to establish a call with the UE 110. The UE 110 may postpone processing of the one or more SIP requests until detection that a predetermined amount of time has passed (e.g., expiry of a timer) without receiving a SIP request. After the predetermined amount of time has passed, the UE 110 may process the one or more SIP requests in response to the detection (e.g., based on a first-in-last-out protocol).

As shown in FIG. 1, an evolved universal terrestrial radio access network (E-UTRAN) 120 may support LTE and may include a number of evolved Node Bs (eNBs) 122 and other network entities that can support wireless communication for user equipments 110 (UEs). Each eNB 122 may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network-triggered services, etc. A mobility management entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A radio access network (RAN) 130 may support GSM and may include a number of base stations 132 and other network entities that can support wireless communication for UEs. A mobile switching center (MSC) 134 may communicate with the RAN 130 and may support voice services, provide routing for circuit-switched calls, and perform mobility management for UEs located within the area served by MSC 134. Optionally, an inter-working function (IWF) 140 may facilitate communication between MME 126 and MSC 134 (e.g., for 1×CSFB).

E-UTRAN 120, serving gateway 124, and MME 126 may be part of an LTE network 102. RAN 130 and MSC 134 may be part of a GSM network 104. For simplicity, FIG. 1 shows only some network entities in the LTE network 102 and the GSM network 104. The LTE and GSM networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

Upon power up, UE 110 may search for wireless networks from which it can receive communication services. If more than one wireless network is detected, then a wireless network with the highest priority may be selected to serve UE 110 and may be referred to as the serving network. UE 110 may perform registration with the serving network, if necessary. UE 110 may then operate in a connected mode to actively communicate with the serving network. Alternatively, UE 110 may operate in an idle mode and camp on the serving network if active communication is not required by UE 110.

UE 110 may be located within the coverage of cells of multiple frequencies and/or multiple RATs while in the idle mode. For LTE, UE 110 may select a frequency and a RAT to camp on based on a priority list. This priority list may include a set of frequencies, a RAT associated with each frequency, and a priority of each frequency. For example, the priority list may include three frequencies X, Y and Z. Frequency X may be used for LTE and may have the highest priority, frequency Y may be used for GSM and may have the lowest priority, and frequency Z may also be used for GSM and may have medium priority. In general, the priority list may include any number of frequencies for any set of RATs and may be specific for the UE location. UE 110 may be configured to prefer LTE, when available, by defining the priority list with LTE frequencies at the highest priority and with frequencies for other RATs at lower priorities, e.g., as given by the example above.

UE 110 may operate in the idle mode as follows. UE 110 may identify all frequencies/RATs on which it is able to find a “suitable” cell in a normal scenario or an “acceptable” cell in an emergency scenario, where “suitable” and “acceptable” are specified in the LTE standards. UE 110 may then camp on the frequency/RAT with the highest priority among all identified frequencies/RATs. UE 110 may remain camped on this frequency/RAT until either (i) the frequency/RAT is no longer available at a predetermined threshold or (ii) another frequency/RAT with a higher priority reaches this threshold. This operating behavior for UE 110 in the idle mode is described in 3GPP TS 36.304, entitled “Evolved Universal Terrestrial Radio Access (E-UTRA); User Equipment (UE) procedures in idle mode,” which is publicly available.

UE 110 may be able to receive packet-switched (PS) data services from LTE network 102 and may camp on the LTE network while in the idle mode. LTE network 102 may have limited or no support for voice-over-Internet protocol (VoIP), which may often be the case for early deployments of LTE networks. Due to the limited VoIP support, UE 110 may be transferred to another wireless network of another RAT for voice calls. This transfer may be referred to as circuit-switched (CS) fallback. UE 110 may be transferred to a RAT that can support voice service such as 1×RTT, WCDMA, GSM, etc. For call origination with CS fallback, UE 110 may initially become connected to a wireless network of a source RAT (e.g., LTE) that may not support voice service. The UE may originate a voice call with this wireless network and may be transferred through higher-layer signaling to another wireless network of a target RAT that can support the voice call. The higher-layer signaling to transfer the UE to the target RAT may be for various procedures, e.g., connection release with redirection, PS handover, etc.

Single radio voice call continuity (SRVCC) provides the ability to transition a voice call from a packet domain (e.g., voice over internet protocol (VoIP) or IP multimedia subsystem (IMS)) to the legacy circuit domain. Variations of SRVCC may support Global System for Mobile Communications (GSM)/Universal Mobile Telecommunications System (UMTS) and CDMA 1× circuit domains. For an operator with a legacy cellular network who wishes to deploy internet protocol (IP) multimedia subsystem (IMS) and voice over IP (VoIP)-based voice services in conjunction with the rollout of a long term evolution (LTE) network, SRVCC may offer VoIP subscribers with coverage over a much larger area than would typically be available during the rollout of a new network. As described in greater detail below, in some embodiments, a network entity such as a core network entity and/or a base station may implement the functionality described herein for improving user experience of a voice call associated with a device, such as a SRVCC device. For example, a base station may detect failures during mobile originated calls from a UE and may transition (e.g., redirect) the UE to another system in an effort to improve user experience.

As described in greater detail below, in some embodiments, the UEs 110 may implement the functionality described herein for improving user experience of a voice call associated with a device, such as a SRVCC device. For example, the UE may maintain timers, counts, and/or thresholds for use in silent redial. UE 110 may also detect a failure during mobile originated call, determine how to attempt retrying the call, select a subsequent system for attempting the call, and attempt to retry the call as described herein.

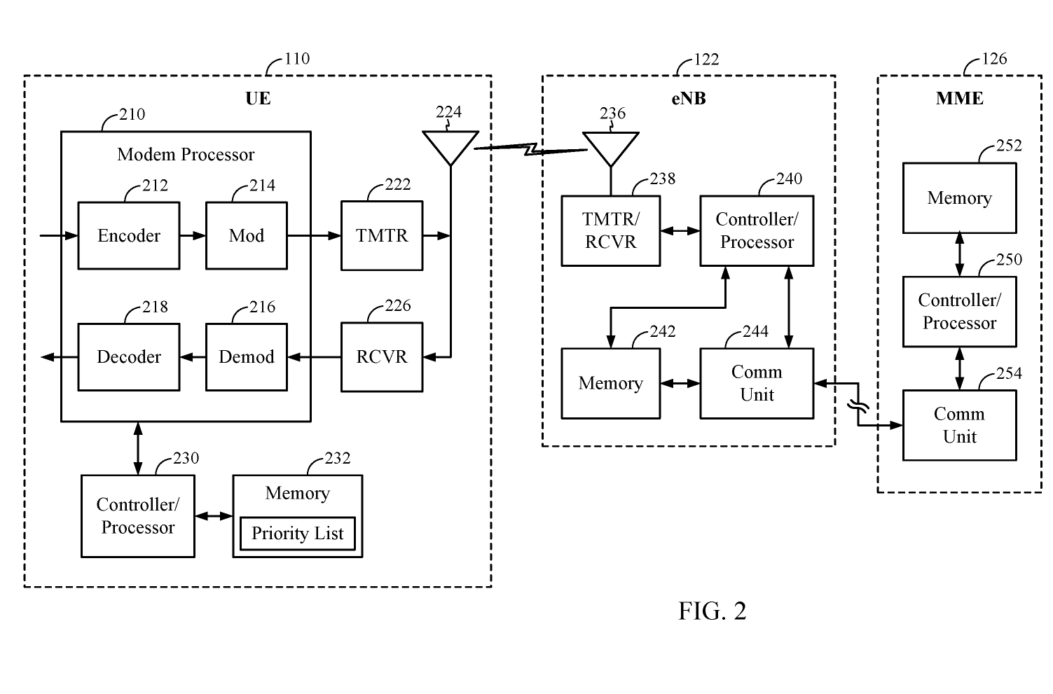

FIG. 2 shows simplified block diagrams of UE 110, eNB 122, and MME 126 of FIG. 1. In general, each entity may include any number of transmitters, receivers, processors, controllers, memories, communication units, etc. Other network entities may also be implemented in similar manner.

At UE 110, an encoder 212 may receive traffic data and signaling messages to be sent on the uplink. Encoder 212 may process (e.g., format, encode, and interleave) the traffic data and signaling messages. A modulator (Mod) 214 may further process (e.g., symbol map and modulate) the encoded traffic data and signaling messages and provide output samples. A transmitter (TMTR) 222 may condition (e.g., convert to analog, filter, amplify, and frequency upconvert) the output samples and generate an uplink signal, which may be transmitted via an antenna 224 to eNB 122.

On the downlink, antenna 224 may receive downlink signals transmitted by eNB 122 and/or other eNBs/base stations. A receiver (RCVR) 226 may condition (e.g., filter, amplify, frequency downconvert, and digitize) the received signal from antenna 224 and provide input samples. A demodulator (Demod) 216 may process (e.g., demodulate) the input samples and provide symbol estimates. A decoder 218 may process (e.g., deinterleave and decode) the symbol estimates and provide decoded data and signaling messages sent to UE 110. Encoder 212, modulator 214, demodulator 216, and decoder 218 may be implemented by a modem processor 210. These units may perform processing in accordance with the RAT (e.g., LTE, 1×RTT, etc.) used by the wireless network with which UE 110 is in communication.

A controller/processor 230 may direct the operation at UE 110. Controller/processor 230 may also perform or direct other processes for the techniques described herein. Controller/processor 230 may also perform or direct the processing by UE. Memory 232 may store program codes and data for UE 110. Memory 232 may also store a priority list and configuration information.

At eNB 122, a transmitter/receiver (TMTR/RCVR) 238 may support radio communication with UE 110 and other UEs. A controller/processor 240 may perform various functions for communication with the UEs. On the uplink, the uplink signal from UE 110 may be received via an antenna 236, conditioned by receiver 238, and further processed by controller/processor 240 to recover the traffic data and signaling messages sent by UE 110. On the downlink, traffic data and signaling messages may be processed by controller/processor 240 and conditioned by transmitter 238 to generate a downlink signal, which may be transmitted via antenna 236 to UE 110 and other UEs. Controller/processor 240 may also perform or direct other processes for the techniques described herein. Controller/processor 240 may also perform or direct the processing by eNB 122. Memory 242 may store program codes and data for the base station. A communication (Comm) unit 244 may support communication with MME 126 and/or other network entities.

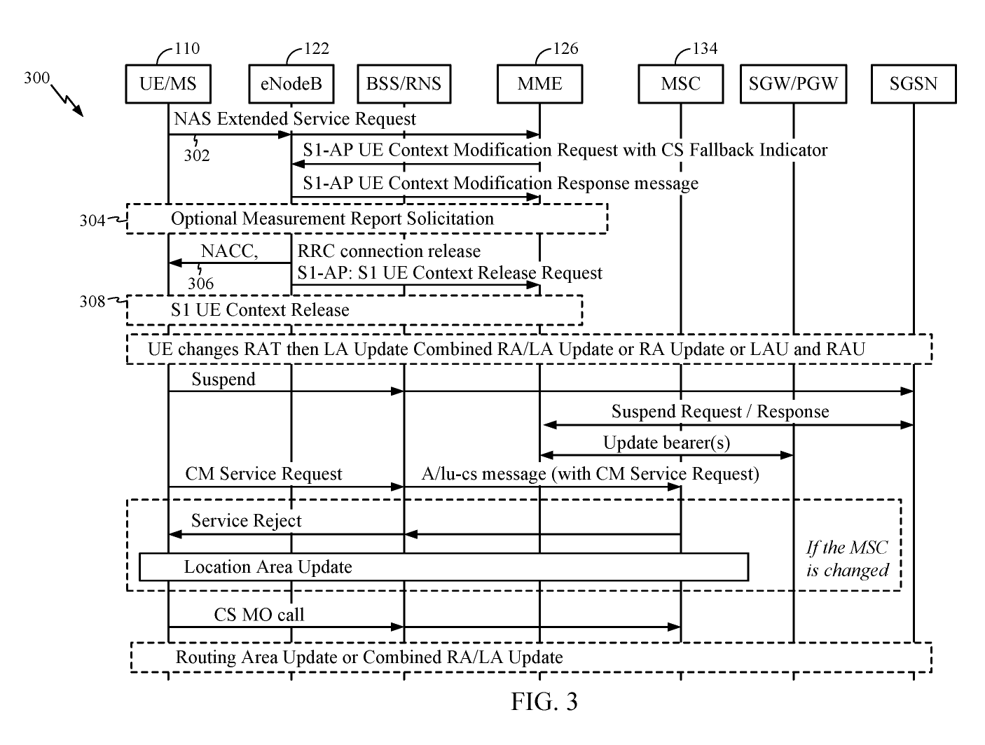

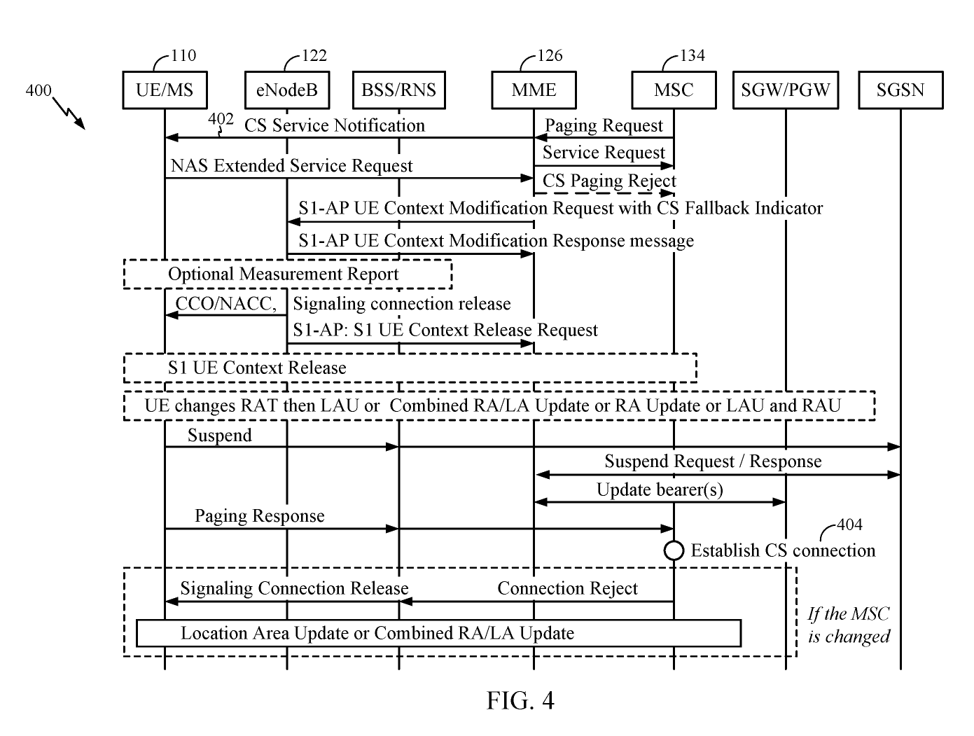

At MME 126, a controller/processor 250 may perform various functions to support communication services for UEs. Controller/processor 250 may also perform or direct the processing by MME 126 in FIGS. 3 and 4. Memory 252 may store program codes and data for MME 126. A communication unit 254 may support communication with other network entities.

### Example Circuit-Switched Fallback

FIG. 3 illustrates an example call flow 300 for circuit-switched (CSFB) when a UE (e.g., UE 110), which may support EUTRAN/UTRAN/GERAN protocols, makes a mobile-originated (MO) call, in accordance with certain aspects of the present disclosure. While the UE 110 is camped on a long-term evolution (LTE) network 102 that may not support voice services, the UE 110 may fall back to a 1× network connected to the mobile switching center (MSC) 134 in order to make the MO call. As shown, the call setup procedure may begin at 302 where the UE 110 may initiate a non-access stratum (NAS) extended service request (ESR). At 304, the UE may receive CS radio access technology (RAT) candidates from a measurement report. At 306, the LTE network 102 may assist the UE 110 in the mobility procedure in a network assisted cell change (NACC). For example, if an interface between the MSC 134 and the mobility management entity (MME) 126 is down, the LTE network 102 may inform the UE 110 to retry the call setup after a set period. At 308, the UE may receive a mobility command from the LTE network 102 indicating the target RAT/band/channel the UE 110 may need to tune to in order to find CS services and in order to continue with the call setup procedure.

FIG. 4 illustrates an example call flow 400 of CSFB when a UE 110 receives a mobile-terminated (MT) call, according to certain aspects of the present disclosure. Operations may be similar to those described in FIG. 3, however, the UE 110 may initiate the call setup procedure after receiving a 1× page at 402 (CS SERVICE NOTIFICATION). The MSC 134 may deliver the 1× page to the UE 110 (e.g., forward the page through SGs interface to MME 126). The 1× page may comprise caller line identification information.

### Example Methods and Apparatus to Improve Network Coverage Using Rate Adaptation

Aspects of the present disclosure provide a mechanism for a media receiver (e.g., a first UE) to signal, to a network entity, its capability to support rate adaptation during a media session with a media sender (e.g., second UE). Such a capability may allow the media receiver to request the media sender change its encoder to a more robust mode when it detects packet losses. As used herein, the relative term “more robust” when applied to a codec generally refers to a codec that is capable of tolerating a higher packet loss rate (PLR) than a current codec. Thus, switching to a more robust codec may allow a UE to tolerate a higher PLR. Given this information, the network entity may adjust handover thresholds accordingly, helping avoid premature handover and the corresponding overhead, delay, and possible degradation of quality of the media session.

While the techniques presented herein are described with reference to voice over IP (VoIP) sessions, the techniques are broadly applicable to any type of media sessions where a media receiver (e.g. a UE) is capable of requesting a media sender to change codec configurations (e.g., in response to detecting a PLR above a threshold). By signaling the ability to adapt rates in this manner to a network entity, the network entity may be able to appropriately set handover thresholds to avoid unnecessary (premature) handovers. As used herein, the term codec configuration generally refers to different configurations involving a same codec type or different codec types, such as adaptive multi-rate (AMR) and enhanced voice service (EVS) channel aware mode.

The thresholds set based on the UE capability for rate adaptation may be used to trigger different types of handovers. These may include handovers between different types of radio access networks (RANs), such as from a packet-switched RAN to a circuit-switched RAN, or handovers between base stations within a same type of RAN.

As noted above, aspects of the present disclosure may allow a network entity to determine a MaxPLR supported by a VOIP terminal and/or adjust one or more handover thresholds based on the MaxPLR supported by a VOIP terminal that employs, for example, application layer redundancy and/or the rate adaptability.

By repeating uplink transmission of voice frames (e.g., in different VoIP packets), such redundancy schemes may increase reliability of uplink transmissions from UEs in low or poor coverage areas (e.g., such as a cell edge), allowing the UE to effectively tolerate higher PLRs.

An eNB (or other network entity) may update (e.g., increase) handover thresholds for UEs that employ application layer redundancy and, as a result, can tolerate higher MaxPLRs. By increasing handover thresholds, an eNB may not be as quick to handover a UE from a packet switched (PS) radio access network (RAN) to a circuit switched (CS) RAN. In some cases, this may be desirable, particularly for operators that are motivated to keep UEs on the PS RAN (e.g., as they try and phase out support of CS RANs).

Aspects of the present disclosure provide techniques for allowing a UE to provide signaling of information that allows a network entity (e.g., a core network entity or an eNB) to determine a MaxPLR, accounting for application layer redundancy. As will be described in greater detail below, the UE may explicitly signal its MaxPLR or may signal information (e.g., codec and redundancy or ability for rate adaptation) allowing the network entity to determine the MaxPLR itself. The signaling may be direct to the eNB (e.g., via RRC signaling) or indirect (e.g., via SIP signaling).

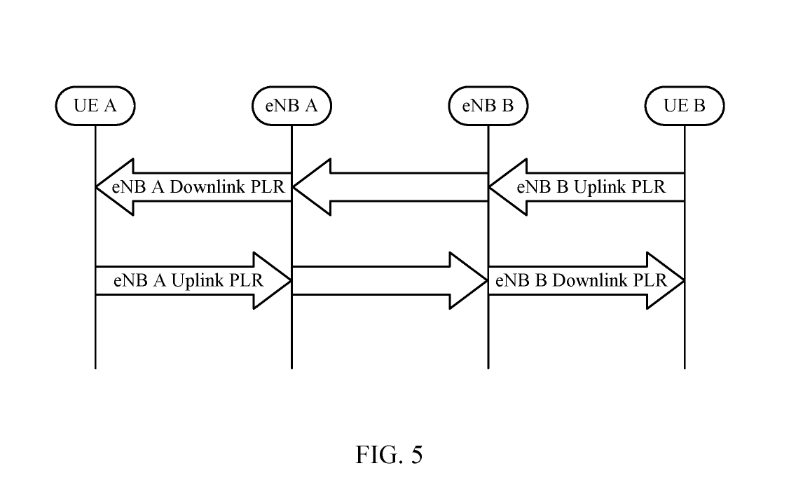

FIG. 5 illustrates an example voice over IP (VOIP) scenario involving two UEs (UE A and UE B), in which aspects of the present disclosure may be practiced.

For example, aspects of the present disclosure may help eNBs (e.g., eNB A and/or eNB B) or other network entities set the one or more handover thresholds. These thresholds may be set in an effort to ensure that the end-to-end error rate across the transport path between UE A and UE B does not exceed a maximum PLR based on current codes, accounting for advanced techniques, such as application layer redundancy. Accounting for an increase in MaxPLR may help avoid unnecessarily handing over the UEs from a packet switched network to a circuit switched network.

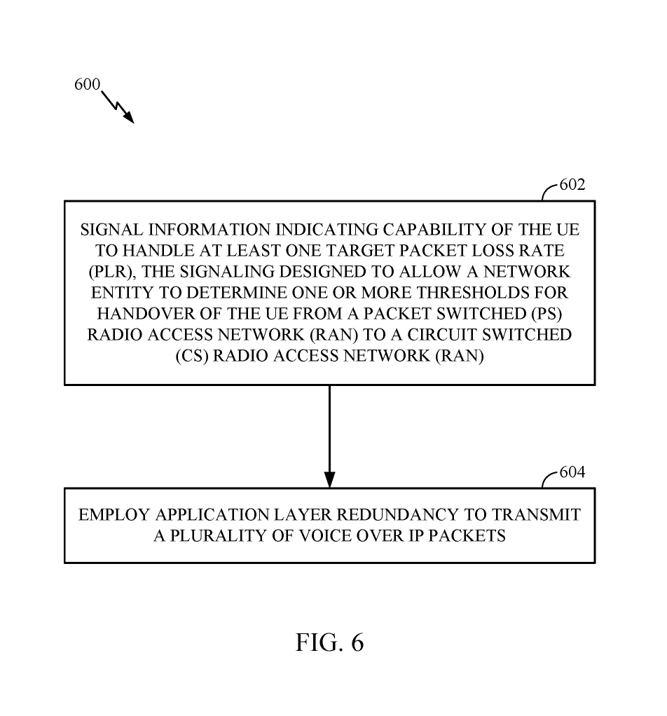

FIG. 6 illustrates example operations 600 for wireless communications by a UE (e.g., a VoIP terminal), according to aspects of the present disclosure. For example, operations 600 may be performed by UE A and/or UE B of FIG. 5.

The operations 600 begin, at 602, by signaling information (explicitly or implicitly) indicating capability of the UE to handle at least one target packet loss rate (PLR), the signaling designed to allow a network entity to determine one or more thresholds for handover of the UE from a packet switched (PS) radio access network (RAN) to a circuit switched (CS) radio access network (RAN).

At 604, the UE employs application layer redundancy to transmit a plurality of voice over IP packets. In aspects, operations 600 further comprise receiving signaling, while the UE is participating in a voice call over the PS RAN, for the UE to handover from the PS RAN to the CS RAN based on the determined thresholds.

According to certain aspects, the signaling is provided via radio resource control (RRC) signaling. According to certain aspects, the signaling is provided via Session Initiation Protocol (SIP) signaling. According to certain aspects, the information comprises an indication of a maximum PLR. In such aspects, operations 600 may further comprise determining the maximum PLR based on the employed application layer redundancy. The information may comprise an indication of an amount of redundancy supported by the UE for each of one or more codecs.

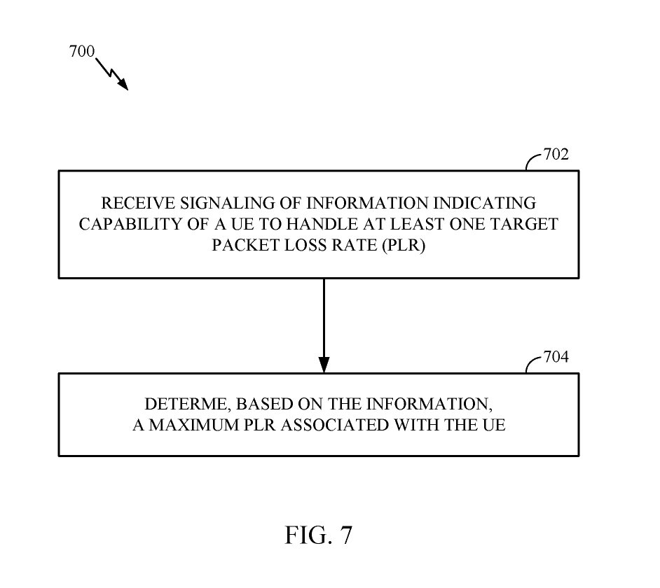

FIG. 7 illustrates example operations 700 for wireless communications by a network entity (e.g., an eNB or a core network entity), according to aspects of the present disclosure. For example, operations 700 may be performed by eNB A and/or eNB B of FIG. 5.

The operations 700 begin, at 702, by receiving signaling of information indicating capability of a UE to handle at least one target packet loss rate (PLR). At 704, the eNB determines, based on the information, a maximum PLR associated with the UE.

Based on the maximum PLR, the network entity (e.g., an eNB) may determine one or more thresholds for handover of the UE from a packet switched (PS) radio access network (RAN) to a circuit switched (CS) radio access network (RAN). The network entity may decide, while the UE is participating in a voice call over the PS RAN, whether to cause handover of the UE from the PS RAN to the CS RAN based on the determined thresholds.

According to certain aspects, the information comprises an indication of an amount of redundancy supported by the UE for each of one or more codecs. In such aspects, the operations 700 further comprise determining a maximum PLR for each indication of redundancy supported by the UE for each of one or more codecs. Operations 700 may further comprise transmitting (e.g., by a core network entity) the determined maximum PLR to another network entity (e.g., an eNB).

As noted above, in some cases, a VoLTE terminal may explicitly signal its MaxPLR. For example, based on a current codec and application layer redundancy scheme, the VoLTE terminal may determine the MaxPLR it can support. A possible advantage of this approach is that it does not require any calculations by the RAN or core network, although it does not allow the operator direct control over the kind of voice quality it wants to achieve. In other words, the operator may not be able to select the MaxPLR for a particular codec to guarantee a target voice quality.

As noted above, the explicit signaling of the MaxPLR may be done in at least two ways. For example, the VoLTE terminal may use RAN-level signaling (RRC) to send the information directly to the eNB. One advantage of this approach is that it is directly communicated to the eNB and there is no impact to the core network.

As an alternative, or in addition, the VoLTE terminal may use Session Initiation Protocol (SIP) signaling to send the information to the core network which then communicates this to the eNB. In this case, the information (e.g., MaxPLR) may be sent as a Session Description Protocol (SDP) parameter or with SDP parameters.

For example, the VoLTE terminal may send the MaxPLR to a core network entity, such as a call session control function (CSCF). The CSCF may, in turn, communicate this information to another core network entity such as ae Policy and Charging Rules Function (PCRF), which may communicate the MaxPLR to the eNB (serving the VoLTE terminal). One advantage of this approach is that there may be little or no impact to the RAN (e.g., RRC) signaling between the VoLTE terminal and the eNB. It also gives the operator some control over the MaxPLR communicated to the eNB, as the operator may change the MaxPLR value when it passes through the PCRF.

In some cases, rather than receiving explicit signaling of the MaxPLR, a network entity may derive the MaxPLR based on information (e.g., codec information) from the VoLTE terminal. For example, the VoLTE terminal may provide information to the core network that allows the core network to determine, compute and/or derive the MaxPLR that the VoLTE terminal can tolerate.

This information may include the codec modes (codec configurations which may involve one or more codec types), whether application layer redundancy can be used, and/or whether the terminals can autonomously adapt to more robust configurations when experiencing higher packet loss rates. For example, the information can indicate how much application layer redundancy (e.g., 100%, 200%, 300%, etc.) can be applied for each particular codec mode, such as:
AMR 5.9 200% max-red
AMR 12.2 0% max-red
AMR 7.2 100% max-red
   As described above, for example, due to bandwidth constraints, the terminal may support up to 200% redundancy for the adaptive multi-rate (AMR) 5.9 kbps codec mode, but only up to 100% redundancy for the AMR 7.2 kbps codec mode. In some cases, the UE may provide an indication that the UE is able to adapt between particular codec modes and redundancy levels.

As will be, such information (as the ability to adapt codec modes) may be communicated via SIP in the form of SDP parameters that are sent to the CSCF. The CSCF then sends the relevant information to the PCRF which then determines the MaxPLR based on all the information received. The PCRF then communicates the MaxPLR to the eNB. The information can also be communicated directly to the eNB via RAN-level (RRC) signaling. The eNB then derives the MaxPLR based on all the information it receives.

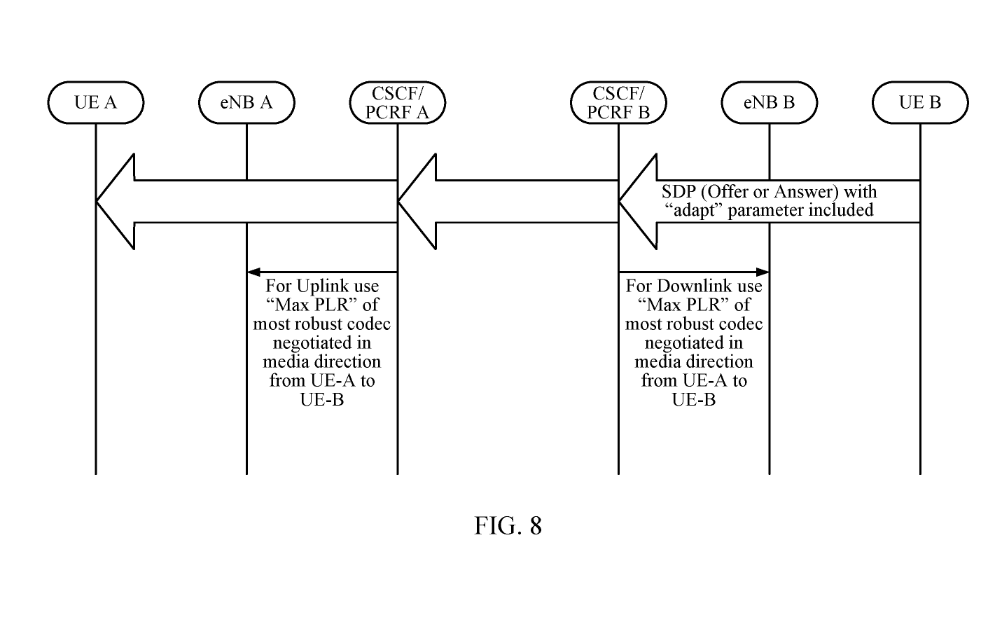

FIG. 8 illustrates an example scenario in which a UE (UE B) signals the ability for rate adaptation via a parameter that may be referred to as an “adapt” parameter. As illustrated, the adapt parameter may be signaled via an SDP message (e.g., an Offer or Answer) sent, for example, when establishing a multimedia session to help each of the parties understand each other in terms of the various multimedia capabilities.

The adapt parameter may allow the network (e.g., via a PCRF and/or CSCF) to confirm a UE will be able to adapt to a more robust codec, for example, to the most robust codec mode negotiated for a media session and to take this into consideration when setting handover thresholds to indicate to the eNB currently serving the UE. In some cases, a network entity may use the presence of the “adapt” parameter (a receiver rate codec configuration or rrcc parameter) in the SDP message to determine what Max PLR to indicate to its eNB as follows.

For example, as illustrated in FIG. 8, if PCRF B detects the adapt parameter (rrcc) is sent from a client (UE B) served by its local eNB (eNB B), then the PCRF can indicate the Max PLR for the most robust codec mode negotiated in the downlink direction to the eNB (eNB B) for its downlink. Similarly, if the PCRF A detects the adapt parameter is sent from the far-end client (UE B in this example), then PCRF A can indicate the Max PLR for the most robust codec mode negotiated in the uplink direction to the eNB (eNB A) for its uplink (in the direction from UE A to UE B).

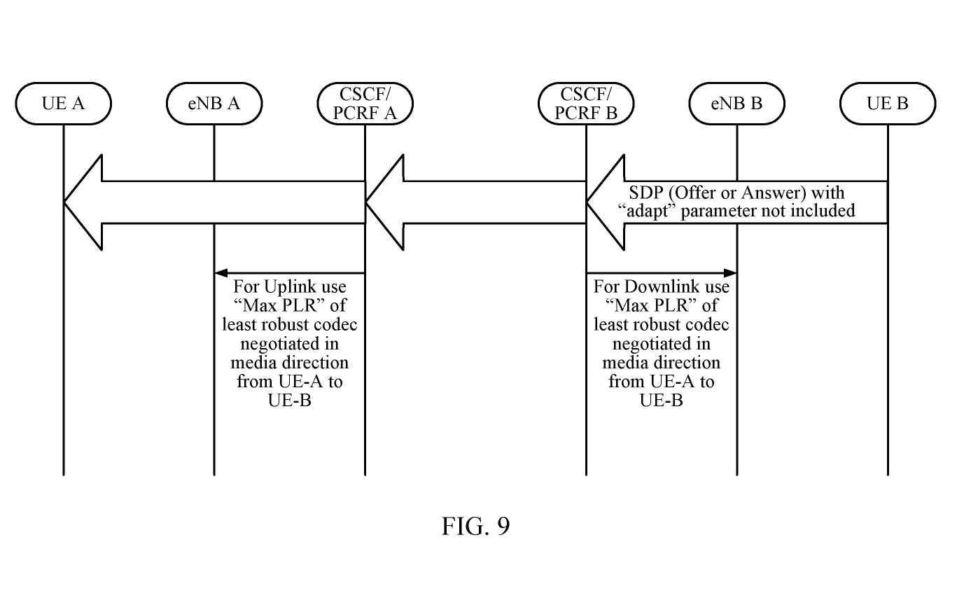

On the other hand, as illustrated in FIG. 9, if the adapt parameter is not detected, PCRF B may indicate the Max PLR for the least robust codec mode negotiated in the downlink direction to eNB B for its downlink (to be safe since UE B has not indicated the ability to stich codec modes). Similarly, if the PCRF A detects the adapt parameter is not sent from the far-end client (UE B in this example), then PCRF A can indicate the Max PLR for the least robust codec mode negotiated in the uplink direction to the eNB (eNB A) for its uplink (in the direction from UE A to UE B).

As noted above, the techniques presented herein are broadly applicable to any type of media sessions where a media receiver (e.g. a UE) is capable of requesting a media sender to change codec configurations. By signaling the ability to adapt rates in this manner to a network entity, the network entity may be able to appropriately set handover thresholds to avoid premature handovers.

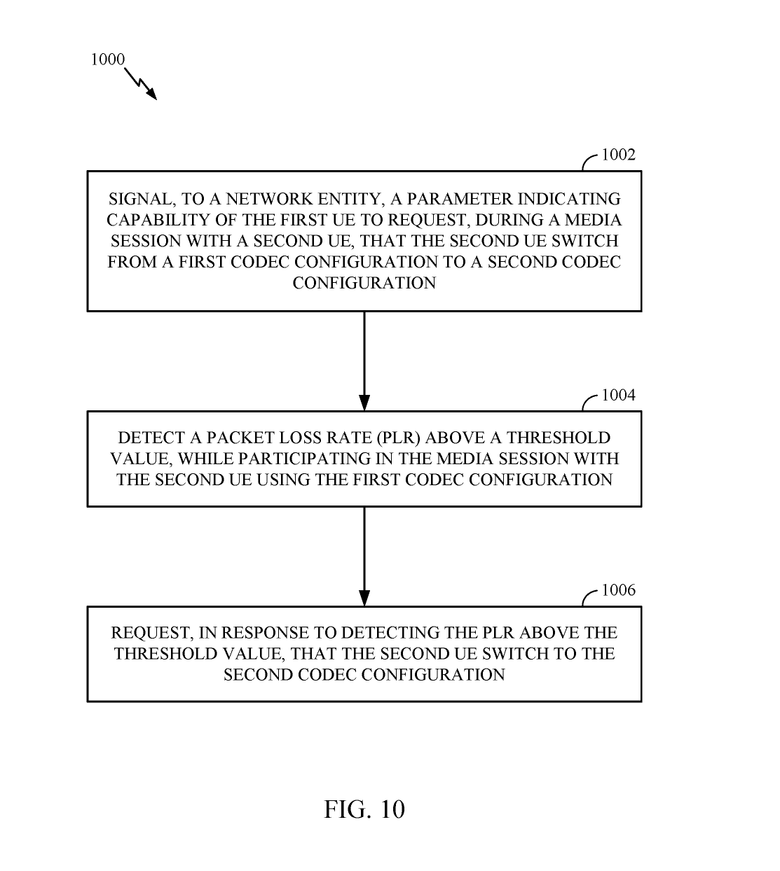

FIG. 10 illustrates example operations 1000 for wireless communications by a first UE, in accordance with certain aspects of the present disclosure. For example, operations 1000 may performed by UE B (and/or UE A) of FIG. 8 to signal PCRF B (and/or PCRF A). For example, operations 1000 may be performed by the UE of FIG. 2 (and/or by one or more of the UE processors thereof).

Operations 1000 begin, at 1002, by signaling, to a network entity, a parameter indicating capability of the first UE to request, during a media session with a second UE, that the second UE switch from a first codec configuration to a second codec configuration. At 1004, the first UE detects a packet loss rate (PLR) above a threshold value, while participating in the media session with the second UE using the first codec configuration. At 1006, the first UE requests, in response to detecting the PLR above the threshold value, that the second UE switch to the second codec configuration.

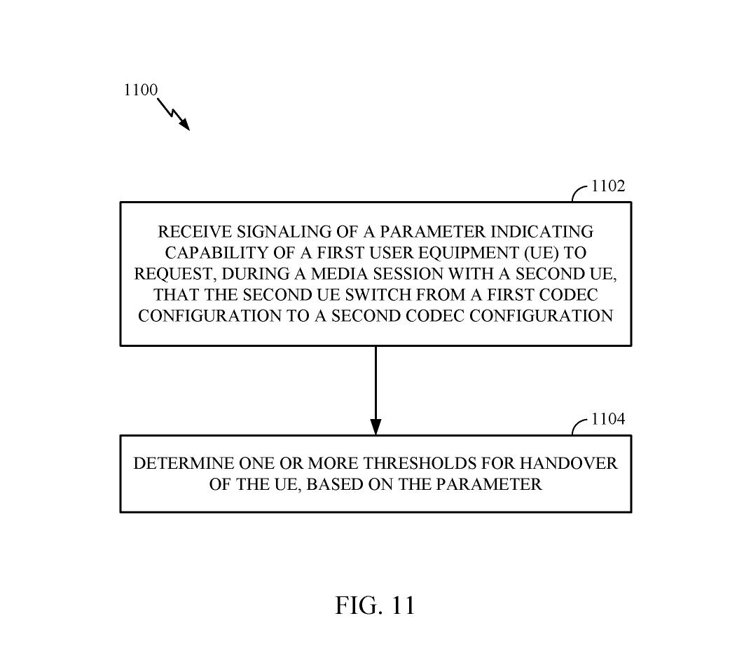

FIG. 11 illustrates example operations 1100 for wireless communications by a network entity, in accordance with certain aspects of the present disclosure. For example, operations 1100 may performed by PCRF B (and/or PCRF A) of FIG. 8 to process signaling of a rate adapt parameter signaled by UE B (and/or UE A) performing operations 1000 of FIG. 10. For example, operations 1100 may be performed by one or more of the eNB or the MME of FIG. 2 (or by one of the processors thereof).

Operations 1100 begin, at 1102, by receiving signaling of a parameter indicating capability of a first user equipment (UE) to request, during a media session with a second UE, that the second UE switch from a first codec configuration to a second codec configuration. At 1104, the network entity determines one or more thresholds for handover of the UE, based on the parameter.

As noted above, the adapt parameter may be used to indicate the ability to request a switch between different codec configurations involving a same codec type or different codec types, such as adaptive multi-rate (AMR) and enhanced voice service (EVS) channel aware mode. A network entity may set handover thresholds (used to trigger different types of handovers) based on the indicated adapt parameter.

As described herein, an SDP signaled adapt parameter (rrcc) may indicate that a media receiver (e.g., UE B in FIG. 8) has the ability to request a more robust codec (e.g., up to the most robust codec configuration supported by the UE) when it detects high packet loss. As noted above, the most robust codec configuration can include a robust codec mode, use of application layer partial and full redundancy, use of transport or application layer error correction, or any combination of these mechanisms.

In some cases, the rate adapt parameter (rrcc) may be generic as to media type. In other words, the adapt parameter may indicate that when a client receiving media detects packet losses higher than that tolerable by a current codec configuration in use, the client supports sending a request to the media sender to use a more robust codec configuration, regardless of the media type involved in the session (e.g., whether video, voice, some other audio, or text).

In other cases, however, the rate adaptation parameter may be media-specific. In such cases, if supported for one codec type, the indicated parameter may apply for all codecs of that same media type negotiated in a session. In other words, the adapt parameter may be defined to only indicate robustness requests within a certain RTP payload type (codec) and may not be expected to make requests across codec types of the same media.

Signaling a media specific adapt parameter may make sense, for example, if the UE supports request for more robust configurations for a particular codec type (e.g., AMR-WB) where it is reasonable to expect that the UE can make similar adaptations for any other codec of the same media type (e.g. EVS). In such cases, there may not be a need to enable adaptation requests across different codec types of the same media type.

In certain scenarios however, multiple codec types may be negotiated for receiving media, for example, for sessions where the codec type may switch depending on the capabilities of the active media sender for a conference involving users with different capabilities. In such cases, it may be beneficial for the media receiver to be able to attempt to switch the codec type as determined by the capabilities of a media sender involved in the conference.

Dynamically switching codec types in an active session, however, presents challenges and may cause disruptions in the media quality in some cases, due to processing overhead involved to support the different codecs. In other words, supporting a seamless transition may be challenging to implement.

In certain scenarios, such as Multi-party Multi-stream Conferencing Media Handling (MMCMH) sessions, multiple codec types may be negotiated for a single media type. In such cases, the PCRF/PCC may not be able to rely on the UEs to adapt to the most robust mode among all those negotiated. In such cases, the PCRF/PCC may need to rely on the PLR of the least robust among the most robust mode of each codec type negotiated (e.g., the MIN [MAX (codec type 1), MAX (codec type 2), MAX (codec type 3) . . . ]).

In some cases, an in-band codec mode request (CMR) may be directed to a particular payload type by relying on the payload type of the media sent in the direction of the CMR. For other requests, a different mechanism may be used to distinguish which codec type the robustness request is being made.

In some cases, the SDP adapt parameter may be defined in a manner that allows different media receivers participating in media session to independently indicate their capability to adapt to the most robust configuration. In other words, this approach may allow for asymmetric support for adaptation. This may allow for different thresholds to be set independently in each direction of media transmission.

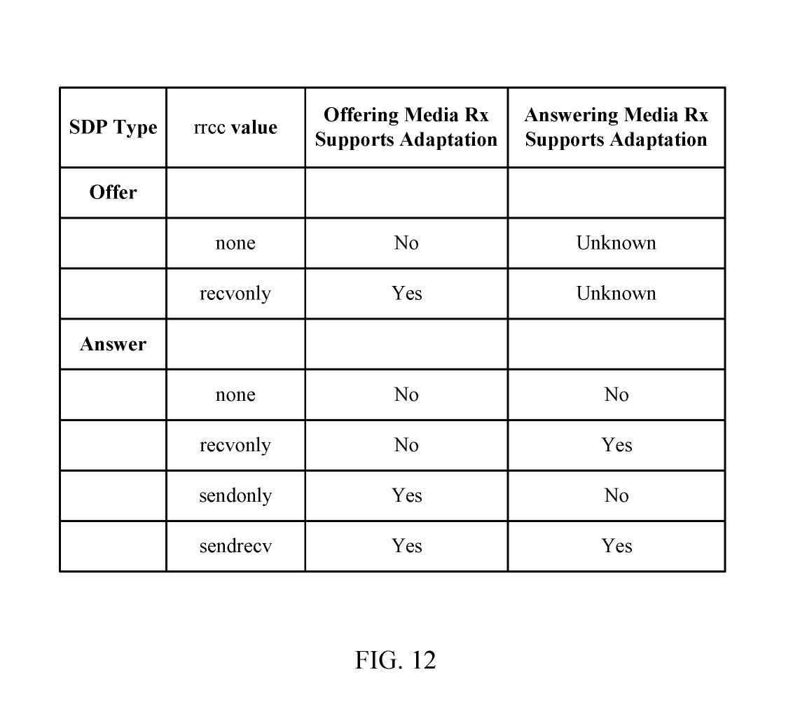

FIG. 12 illustrates an example table indicating how values of an adapt parameter (rrcc) may be defined to indicate the different adaptation support scenarios. For example, a media sender sending an Offer may indicate support for adaptation (rrcc=‘recvonly’) or no support (rrcc=‘none’). An Answer (to the Offer) may depend, in part, on the Offer. For example, if the Offer indicates no support (with rrcc=‘none’) then the Answer can indicate support (with rrcc=‘recvonly’) or no support (with rrcc=‘none’). If the Offer indicates support (with rrcc=‘recvonly’) then the Answerer can indicate support (e.g., with rrcc=‘sendrecv’) or no support (e.g., with rrcc=‘sendonly’).

In some cases, an adapt parameter may be defined to indicate whether a media sender can dynamically change between codecs (encoders) when requested by the media receiver (e.g., a “Media sender encoder switch”). In such cases, if multiple codecs are negotiated and the PCRF sees that codec switching is not supported by a terminal, then the PCRF may take this into account. For example, if the PCRF does not know which codec will be in use, it may have to use a MaxPLR of the codec whose most robust configuration is the least “robust” among all the negotiated codecs. In some cases, multiple codecs may not be supported in an SDP Answer, in which case an indicated parameter may apply to a specific codec type.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components.

For example, means for transmitting may comprise a transmitter 222 and/or an antenna(s) 224 of the UE 110 or far-end user 511 and a transceiver 238 or antenna(s) 236 of eNB 122. Means for receiving may comprise a receiver 226 and/or an antenna(s) 224 of the UE 110 or far-end user 511 and transceiver 238 and/or antenna(s) 236 of eNB 122. Means for determining, means for refraining, means for postponing, means for processing, means for detecting, and/or means for initiating may comprise a processing system, which may include one or more processors, such as modem processor 210 of the UE 110 or controller/processor 240 of eNB 122, for example.

According to certain aspects, such means may be implemented by processing systems configured to perform the corresponding functions by implementing various algorithms (e.g., in hardware or by executing software instructions). For example, various operations shown in FIGS. 6 and 10 may be performed by one or more of processors 210 or 230 of FIG. 2, while operations shown in FIGS. 7 and 11 may be performed by one or more processors of a network entity, such as processors 240 or 250 shown in FIG. 2.

The various algorithms may implemented by a computer-readable medium that may be a non-transitory computer-readable medium. The computer-readable medium may have computer executable instructions (e.g., code) stored thereon. For example, the instructions may be executed by a processor or processing, such as modem processor 210 of the UE 110 or processor 240 of eNB 122, and stored in a memory, such as memory 232 of the UE 110 or memory 242 of eNB 122. For example, the computer-readable medium may have computer executable instructions stored thereon for receiving one or more session initiation protocol (SIP) requests, from one or more other UEs, to establish a call with the UE, instructions for postponing processing of the one or more SIP requests until detection that a predetermined amount of time has passed without receiving a SIP request, and instructions for processing the one or more SIP requests in response to the detection.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communication by a network entity, comprising:
receiving signaling of information indicating capability of a UE to handle at least one target packet loss rate (PLR); and
determining, based on the information, a maximum PLR associated with the UE.

2. The method of claim 1, further comprising:
determining, based on the maximum PLR, one or more thresholds for handover of the UE from a packet switched (PS) radio access network (RAN) to a circuit switched (CS) radio access network (RAN); and
deciding, while the UE is participating in a voice call over the PS RAN, whether to cause handover of the UE from the PS RAN to the CS RAN based on the determined thresholds.

3. The method of claim 1, wherein the signaling is provided via at least one of radio resource control (RRC) signaling or Session Initiation Protocol (SIP) signaling.

4. The method of claim 1, wherein the information comprises an indication of a maximum PLR.

5. The method of claim 1, wherein the information comprises an indication that the UE is able to adapt at least one of a codec mode or redundancy level.

6. The method of claim 5, wherein the information comprises an indication that the UE is able to request, during a media session with another UE, that the other UE switch from a first codec configuration to a second codec configuration.

7. The method of claim 6, wherein the first and second codec configurations are associated with different codec types.

8. The method of claim 1, further comprising transmitting the determined maximum PLR to another network entity.

9. The method of claim 8, wherein the other network entity comprises a base station serving the UE.

10. A method for wireless communication by a user equipment (UE), comprising:
signaling information indicating capability of the UE to handle at least one target packet loss rate (PLR), the signaling designed to allow a network entity to determine one or more thresholds for handover of the UE from a packet switched (PS) radio access network (RAN) to a circuit switched (CS) radio access network (RAN); and
employing application layer redundancy to transmit a plurality of voice over IP packets.

11. The method of claim 10, further comprising receiving signaling, while the UE is participating in a voice call over the PS RAN, for the UE to handover from the PS RAN to the CS RAN based on the determined thresholds.

12. The method of claim 10, wherein the signaling is provided via at least one of radio resource control (RRC) signaling or Session Initiation Protocol (SIP) signaling.

13. The method of claim 10, wherein the information comprises an indication of a maximum PLR.

14. The method of claim 10, wherein the information comprises an indication that the UE is able to adapt at least one of a codec mode or redundancy level.

15. The method of claim 14, wherein the information comprises an indication that the UE is able to request, during a media session with another UE, that the other UE switch from a first codec configuration to a second codec configuration.

16. The method of claim 15, wherein the first and second codec configurations are associated with different codec types.

17. A method for wireless communication by a network entity, comprising:
receiving signaling of a parameter indicating capability of a first user equipment (UE) to request, during a media session with a second UE, that the second UE switch from a first codec configuration to a second codec configuration; and
determining one or more thresholds for handover of the UE, based on the parameter.

18. The method of claim 17, wherein:
the first codec configuration is associated with a first maximum packet loss rate (PLR);
the second codec configuration is associated with a second maximum PLR higher than the first maximum PLR; and
the thresholds are determined based on the second maximum PLR.

19. The method of claim 18, wherein the thresholds are also determined based on at least one of de-jitter buffer or packet loss concealment features of the first UE.

20. The method of claim 18, wherein the thresholds are also determined based on a parameter indicating capability of the second UE to request, during the media session, that the first UE switch codec configurations.

21. The method of claim 18, wherein the network entity indicates the determined thresholds to a base station serving the first UE.

22. The method of claim 17, wherein the thresholds are for handover of the UE from a first type of radio access network (RAN) to a second type of RAN.

23. The method of claim 17, wherein:
the first type of RAN comprises a packet switched (PS) RAN; and
the second type of RAN comprises a circuit switched (CS) RAN.

24. The method of claim 17, wherein the thresholds are for handover of the UE between base stations within a same type of radio access network (RAN).

25. The method of claim 17, wherein the media session involves at least one of voice data, audio data, video data, or text data.

26. The method of claim 17, wherein the parameter indicates a capability of the first UE to request that the second UE switch from a first codec configuration to a second codec configuration regardless of a payload type of the media session.

27. The method of claim 17, wherein the parameter indicates a capability of the first UE to request that the second UE switch from a first codec configuration to a second codec configuration for a specific payload type of the media session.

28. The method of claim 17, wherein the parameter is signaled via a Session Description Protocol (SDP) offer.

29. A method for wireless communication by a first user equipment (UE), comprising:
signaling, to a network entity, a parameter indicating capability of the first UE to request, during a media session with a second UE, that the second UE switch from a first codec configuration to a second codec configuration;
detecting a packet loss rate (PLR) above a threshold value, while participating in the media session with the second UE using the first codec configuration; and
requesting, in response to detecting the PLR above the threshold value, that the second UE switch to the second codec configuration.

30. The method of claim 29, wherein the media session involves at least one of voice data, audio data, video data, or text data.

31. The method of claim 29, wherein the parameter indicates a capability of the first UE to request that the second UE switch from a first codec configuration to a second codec configuration regardless of a payload type of the media session.

32. The method of claim 29, wherein the parameter indicates a capability of the first UE to request that the second UE switch from a first codec configuration to a second codec configuration for a specific payload type of the media session.

33. The method of claim 29, wherein the parameter is signaled via a Session Description Protocol (SDP) offer.
